(19) United States
(12) Patent Application Publication
(10) Pub. No.: US 2013/0226703 A1
(43) Pub. Date: Aug. 29, 2013

(54) METHODS FOR USING PHYSICAL PRESENCE IDENTIFICATION FOR ADVERTISING WITHIN VIRTUAL SOFTWARE APPLICATIONS AND ON WEB PAGES

(71) Applicant: Christopher MURPHY, Louisville, KY (US)

(72) Inventor: Christopher MURPHY, Louisville, KY (US)

(21) Appl. No.: 13/406,588

(22) Filed: Feb. 28, 2012

(51) Int. Cl. G06Q 30/02

(52) U.S. Cl. 705/14.58

(57) ABSTRACT

A method for selecting and displaying advertisements directed to an individual using a computer. An individual is provided with a non-transitory tangible storage medium with a unique identifier. The individual inputs the storage medium into a local computer. In response, the individual's profile data and current IP address is sent to an advertising server that selects and displays advertisements to the individual based on the profile data and physical location of the individual.

### FIELD OF THE DISCLOSURE

The present invention relates to Internet advertising in virtual software applications and the use of physical presence identification to improve individual profiling for advertising on web pages.

### DESCRIPTION OF THE BACKGROUND ART

U.S. application Ser. No. 12/079,728, issued on Dec. 6, 2011 as U.S. Pat. No. 8,074,261, is hereby incorporated by reference in its entirety.

As the Internet has progressed, there has been in increase in the commercialization of the communication space, from advertising on search engines, to target advertising on web pages. Along with this boom in commercializing the Internet there has been an attempt to focus the advertising displayed to the individual using web page tags and other web-based profiling. This process, for the most part, has been focused on providing links to vendors that would like to sell products to the individual.

Although online advertising has a great deal of potential, there is a required trust factor between the advertisers and the individual. It is hoped that the individual is providing an accurate identifier to the web page, so that the individual's profile can be used to select pertinent ads. This trust relationship is currently based on a logon process or an email addresses being provided, but an individual can create multiple email address or change email addresses to defeat the profiling process.

There is a need to be able to provide unique physical presence identification to the Internet to be sure of the individual's identity. This process will then provide a higher level of assurance that the profile used to select advertisements to display to the individual is correct. Alternately, in a virtual software environment, where no web pages are used, accurate physical presence identification is provided prior to construction of the virtual software application. The physical location of the individual can be used to target advertisers available for display in the application and increase the type of advertising available.

For example, a customer logging into a virtual software application for banking is physically identified along with their location using the IP address before logon. Using this information, a bank can garner advertisements and can provide advertisements targeted to the state, area code, county, city or town, or even the specific zip code, of the individual. Using the individual's shopping profile, advertisements for a local restaurant, specialty store, bakery, etc can be displayed.

Due to the nature of virtual software applications, the advertising can provide a tremendous value to the individual and an additional revenue stream to the provider. If the individual is in New York one day, the advertising can provide advertisements targeting New York restaurants that day. If the individual is in San Francisco the next day, restaurants in San Francisco can be displayed on that day, thus providing a much greater value to the individual and the advertiser.

Therefore, the use of physical presence in both the Internet environment and in virtual software application increases the accuracy of the advertisements displayed and provides a broader range of advertisements available. From links to coupons, physical presence identification assures the advertiser that the consumer they are targeting is someone that is interested and is local. This assures the consumer that they will not be bombarded with advertisements that are of no interest and the advertiser knows that their advertisement is being displayed to an individual in the immediate area.

There are several models of advertising engines for selecting advertisement within web pages based on tags, keywords or other textual identification. However, these do not apply to any form of advertisement within virtual software applications nor do they use physical location as a criteria for selection of advertisements. By the very nature of virtual software application, there is no browser-based access and thus all browser-based models do not apply.

With the introduction of a virtual software environment and unique physical presence identification, a new model for advertising has emerged. The virtual software environment itself has created a non-browser based opportunity to target advertisements, and the physical presence identification in that environment provides an opportunity to select and display advertisements in a more meaningful way than in a browser-based environment.

While traditional browser-based advertising has been focused on matching an advertisement to the content of a page and a profile when available, the use of the physical presence identifier in virtual software provides the opportunity to garner an accurate profile of an individual. Using this more accurate profile, an advertisement can then be selected for display within this environment and the profile can be provided to a browser-based web page to assist in advertising.

As described above, the use of the physical presence identification process also allows the virtual environment to garner the individual physical location to automatically display local advertisements. This process will make it possible for an advertiser to target advertising down to a state, area code, city, zip code or even a few streets, allowing small local companies to focus Internet and virtual software advertisements to true potential clients

### BRIEF SUMMARY OF THE INVENTION

The methodology disclosed in this document is related to U.S. Pat. No. 8,074,261, for methods and systems for internet security via virtual software. It builds on areas not yet disclosed and claimed such as advertising with virtual software applications and using the physical presence identification provided within this methodology to improve the use of advertising in a browser-based environment.

In general, one aspect of the invention is the physical presence identification that is used to select an individual's profile and physical location. A more accurate way of identifying an individual will provide a more accurate way of selecting and displaying advertisements.

In general, another aspect of the invention is that non-browser based virtual software applications create an environment where advertising does not currently exist and thus all methods currently claimed for web page based advertising will not function and do not apply.

In general, another aspect of the invention is that from a virtual software environment, advertisements can provide links to web pages to allow online purchases, can provide graphical coupons or can print coupons for physical presence shopping.

Through the use of physical identification, a more accurate profile of the individual's interests and buying habits can be constructed and this information can be used to display advertisements with greater assurance that the advertisement may be of interest to the individual.

The present invention contemplates a method for selecting and displaying advertisements directed to an individual using a computer comprising providing to the individual a non-transitory tangible storage medium with a unique identifier that includes a non-browser based module for providing access to a validation server; in response to the individual inputting the storage medium onto a local computer, loading into virtual memory and executing the module and sending the unique identifier to the validation server; upon the validation server verifying that the unique identifier is valid, downloading a first application module; upon receipt of the application module, querying a profile server for the individual's profile data based on the unique identifier of the storage medium; upon receipt of the profile data, querying the physical location of the current IP address of the individual; querying an advertising server using the profile data and physical location of the individual; and selecting and displaying advertisements to the individual using his or her computer based on the profile data and physical location of the individual.

In one embodiment of the invention, the non-transitory recording medium comprises at least one of a CD-ROM, Flash Drive, Memory Chip, and Flash Memory.

In one embodiment of the invention, the first application module may be a logon module and the individual must complete a logon process before any advertisements are displayed.

In one embodiment of the invention, the profile data and physical location of the individual is used to verify that the individual is logged on before the individual is approved for an online purchase.

In one embodiment of the invention, the advertisements can provide links to web pages to allow online purchases, provide graphical coupons, or can print coupons for shopping.

The present invention further contemplates a method of advertising within virtual software applications comprising providing to an individual using a computer a non-transitory tangible storage medium with a unique identifier that includes a non-browser based module for providing access to a validation server; in response to the individual inputting the storage medium onto a local computer, loading into virtual memory and executing the module and sending the unique identifier to the validation server; if the validation server verifies that the unique identifier is valid, downloading a first application module; upon receipt of the application module, querying a profile server for the individual's profile data based on the unique identifier of the storage medium; upon receipt of the profile data, querying the physical location of the current IP address of the individual; querying an advertising server using the profile data and physical location of the individual; and selecting and displaying advertisements to the individual using his or her computer based on the profile data and physical location of the individual.

### BRIEF DESCRIPTION OF THE DRAWINGS

A more complete appreciation of the present disclosure and many of the advantages thereof will be readily obtained as the same becomes better understood by reference to the following detailed description when considered in connection with the accompanying drawings, wherein:

FIG. 1 illustrates an example of an advertising database used to deliver advertisements to a virtual software environment.

FIG. 2a illustrates a distributable medium being connected to a local computer and the process wherein an individual's profile data is used to select and display advertisements.

FIG. 2b illustrates a distributable medium being connected to a local computer and the process wherein an individual's profile data and physical location are used to select and display advertisements.

FIG. 3 illustrates the use of a distributable medium being connected to a port on a local computer to create a virtual environment and a flowchart which depicts the process wherein an individual's presence and profile is verified and the individual's profile data and physical location is then used to select and display advertisements.

### DETAILED DESCRIPTION OF THE INVENTION

The following exemplary embodiments are set forth to aid in an understanding of the subject matter of this disclosure, but are not intended, and may not be construed, to limit in any way the claims which follow thereafter. Therefore, while specific terminology is employed for the sake of clarity in describing some exemplary embodiments, the present disclosure is not intended to be limited to the specific terminology so selected, and it is to be understood that each specific element includes all technical equivalents which operate in a similar manner.

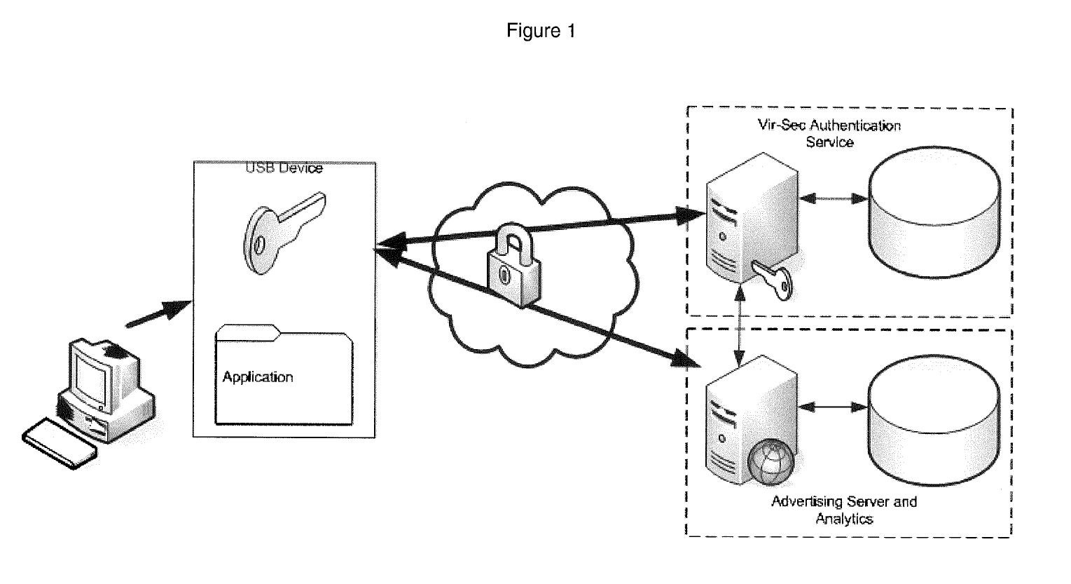

FIG. 1 illustrates an advertising database for use within virtual software applications. The advertisement database is not limited to the fields described in this disclosure, fields may be removed and additional fields added based on the design of the application or the provider's needs. The fields include: an Index field, this can be auto incrementing and assures each record is unique; Advertiser Name; Content field, this can contain but is not limited to PNG, GIF, JPG, FLA, SWF, MPEG, MP3, MOV, AVI, etc or links to this content that can be used to load the content; Link which may open a browser-based web page based on user interaction; Print Content, which may print an advertisement or coupon based on user interaction; Category, which can be used to match the advertisement to the individual's profile; Physical Location Identifier(s), which can assist in further limiting the advertisements displayed, and Selection Criteria, which can limit an advertisement's client demographics from international to a single street.

User interaction is to include event driven functionality such as “mouse over” where the movement of the curser over an advertisement initiates an action and “mouse off”, which stops the event operation while the curser is no longer over the advertisement. Clicking on an advertisement can initiate an audio/video presentation or stop a presentation from executing.

Advertisements may include brand identification, products, or services. Advertisements may provide public notices, from public service announcements, to political advertisements, to legal notices. The term advertisement is not meant to be limited to the disclosed list and may include any type of advertising that may be displayed to an individual.

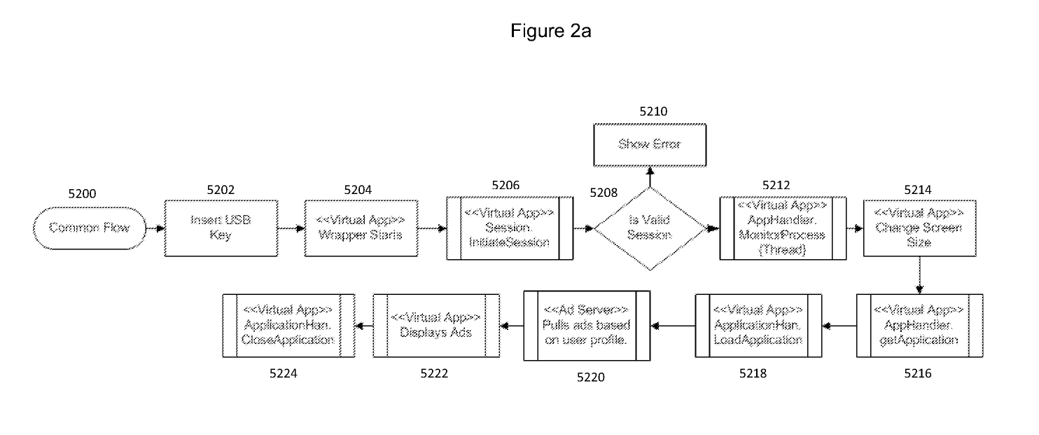

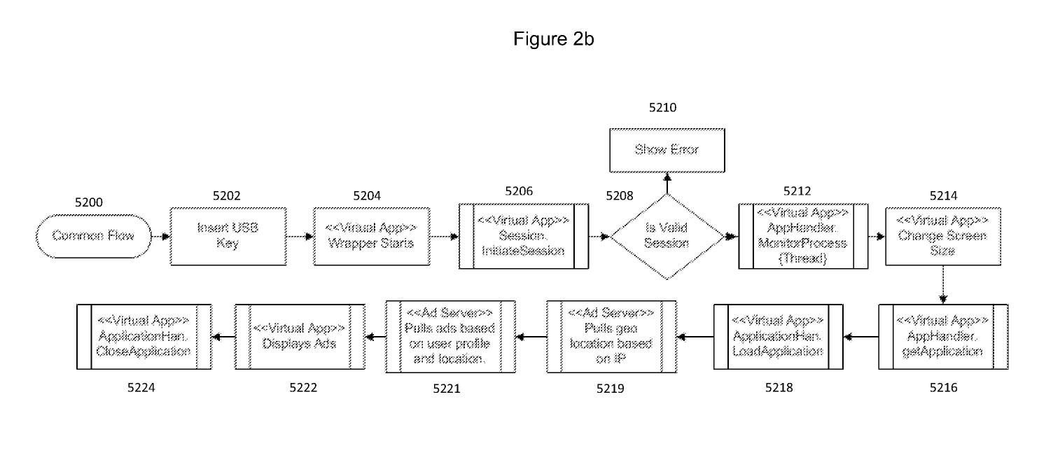

In FIGS. 2a and 2b, a distributable medium is connected to a local computer using a port S202. An application module on the distributable medium is executed. The executed module creates a virtual environment, reads a unique identifier on the medium, and sends it to a validation server(s). The validation server(s) verify that the unique identifier is valid and returns a response to the virtual environment S208. Assuming the response is valid, the virtual environment then calls the application server(s) and the first application module to be loaded into the virtual environment S212. The first application module then calls a profile server(s), queries the individual's profile based on the distributable medium's unique identifier and returns the result to the first application module.

In FIG. 2a, the first application module, in response to the return of the profile data, queries the advertising server(s) and selects advertisements S220 and returns the advertisements for display within the first application module S222.

In FIG. 2b, the first application module, in response to the return of the profile data, queries the physical location of the current IP address of the individual S219 and when the physical location is returned, the first application module uses both the profile and physical location to query the advertising server(s) S221 and returns advertisements for display S222.

The process is not intended to be limited to being called from the first application module and also is not limited to being initiated prior to a second factor of verification. The individual's profile may be stored on a unique server or may be part of an existing database and server configuration. For example, in a banking environment, the first application module may be a logon module and the bank may choose to wait until the individual completes logon before displaying advertisements. The bank may also choose to display advertisements on or within multiple modules thus not limiting advertisements to a single application module.

In addition, the bank may maintain a user profile, which it uses for fraud prevention and may choose to use that database to select an individual's profile. The descriptions in FIGS. 2a and 2b are to be considered examples of the process but not limitations of the functionality of advertising within the virtual software application. Thus the descriptions in FIGS. 2a and 2b are to meant to include all logical extensions of the processes described.

In one embodiment of the present disclosure, a bank may also choose to use physical identification and virtual software application to assist in preventing identity theft and fraudulent charges in a web pages, i.e., browser based environment while at the same time providing a marketable profile to online vendors.

Non-limiting examples of types of distributed media that can be utilized include CD-ROM, Flash Drive, Memory Chip, Flash Memory or any other type recording medium including, but not limited to magnetically or optically recorded media.

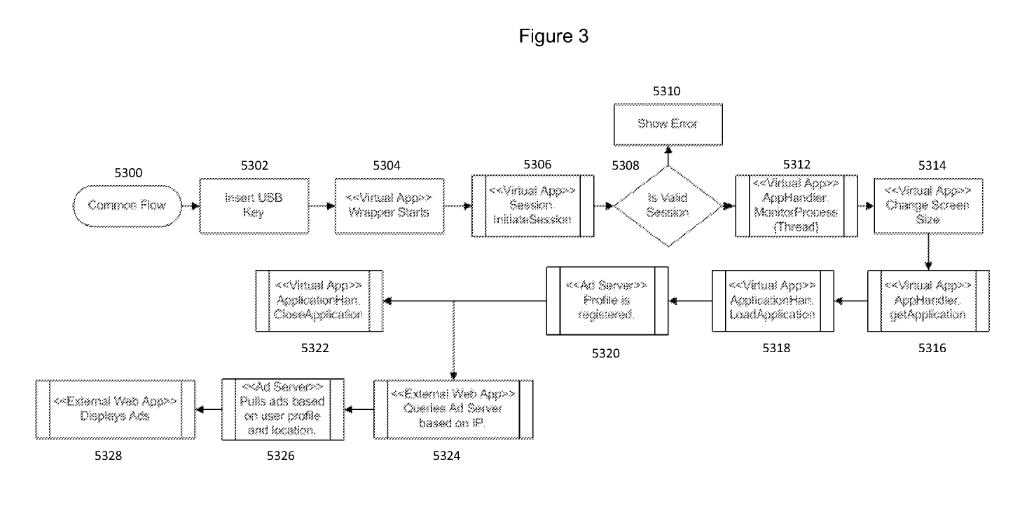

FIG. 3 illustrates the use of a distributable medium being connected to a port on a local computer S302. An application on the medium creates a virtual environment, connects to a validation server(s), read the unique identifier on the medium and send the data for validation S308. The validation server(s) validates the unique identifier and is then returned on a path to the first logon module Sd12. The virtual environment then calls the application server(s) and the first application module is loaded S318.

As described in FIGS. 2a and 2b, advertisements can be displayed. Again, in FIG. 3, the first application module then provides functionality to log on for online banking or log on for online credit card validation. It is not the intent to claim methodology related to virtual software application, so the avenue for online banking ends with loading remaining banking application modules.

In FIG. 3, a physically present application module is loaded into the virtual environment and the banks server(s) store a temporary IP address for the individual being validated. This IP address is stored for the length of the session and deleted upon termination. A bank may choose to set times related to the length of time a session will remain active before requiring additional validation that the individual is present or may leave the termination of a session strictly up to the individual. It is not the intent of this disclosure to limit logical processes but to provide a basis for explanation of the methodology.

Referring to FIG. 3, the credit card validation module remains loaded and active and now allows a bank to be aware that the individual is present on the Internet. The individual then interacts in the current browser-based web page methodology to go to a web site to shop and make purchases. The user then uses some type of shopping card process to validate their purchases and enter payment information. The payment information is then processed through a gateway to the bank for validation.

The bank then checks to verify that the individual is logged into the bank credit card validation module. If the individual is not logged in, the bank rejects the purchase. If the individual is present, the bank then validates the charge and returns authorization or rejection as it currently does.

Again, in FIG. 3, for a fee, upon the receipt of an authorization request, the bank verifies the individual is present, queries the individual's profile and returns the profile data along with the authorization so that the browser-based web page can, with increased assurance of accuracy, select advertisements to display on the web page.

One model of virtual software in which the subject invention may be applied can be a banking virtual software application, as described in U.S. Pat. No. 8,074,261, in which an individual uses a distributable medium, i.e., physical presence identifier, to gain access to the virtual software application for banking. The subject invention is not limited to banking. It is understood based on this disclosure that using a distributable medium for physical identification, a bank knows that the authorized user is present.

In this embodiment, the user connects their unique distributable medium to a computer with an active Internet connection. An application on the medium creates a virtual environment and when executed, the application creates an encrypted tunnel to a validation server(s), and the application then reads the unique encrypted serial number on the medium and sends it to the validation server(s). At the validation server(s), the unique serial number is validated and a response is returned to the virtual environment. The responses returned are not limited to valid or invalid, but in this example we will use those two options. If the response is invalid, the returned value may be “invalid” and a message describing the reason. If the response is valid, the returned value may be “valid” and a path to a logon module. There are multiple ways to create an encrypted tunnel to the banks logon module and all communication methods will ensure a second factor of authorization is required, such as a User Name and Password.

There are multiple ways to extract information related to the individual buying/shopping profile. For this example, upon loading the bank's logon module, the bank can use the unique serial number on the distributable medium to query the individual's profile. The bank can also capture the IP address of the individual at the time of access.

Using these two pieces of information, the unique serial number of the individual and the current IP location of the individual, meaningful advertisements may be displayed. For example, national advertisements from a sporting goods store could be displayed for an individual with a history of making such purchases or an advertisement for a new Italian restaurant could be displayed in that individual's zip code. In this way, the individual can see quality advertisements for a restaurant that is local, whether they are in New York or San Francisco, simply based on their profile and IP address.

Based on this understanding, an advertisement database can be created to feed advertisements. This database can have data fields for containing advertisement images, a field to contain advertisement type whether a link, coupon, or some other type of advertisement, a field for advertisement area (i.e. international, national, state, county, city zip code, area code or some combination of these or other area identifiers.) It is understood that this example is not meant to limit but rather to provide am meaningful example.

The bank receives the notification that the individual has been validated and sends the logon module to the local computer to be loaded into then virtual environment. The logon module then sends the unique serial number and IP address to the bank to query advertisements. A query to get the physical location of the IP address is executed. Then using the individual's unique serial number and physical address, advertisements are selected from the advertisement database and sent to the local computer for display.

These advertisements, when clicked, may open a browser to interact with the advertiser or may print coupons to bring to a local advertiser or may provide some other form of interaction.

In one embodiment of the disclosure, the use of a physical presence identifier using a distributable medium can provide validation of the individual being online when a browser-based purchase is being executed. A user connects their distributable medium into a local computer, validates the device, loads a logon module enters their User Name and Password and then chooses a logon for shopping option. This process will allow the bank to know that for the period of time that the user is logged on it is appropriate to approve browser-based purchases. The bank may store the IP address of the individual for the length of their shopping session and then require that web-based vendors send the IP address of the individual entering the credit card information online. Then, when the bank gets a query from a vendor to approve an online purchase, the bank can not only verify that the credit card information entered is correct, but can also validate that the individual is logged on for purchases and the bank can verify the IP address of the distributable medium matches the IP address of the person entering credit card purchase information. This process provides the ability to verify credit card information, physical presence and location of the person making the purchase, thus eliminating anonymity in an anonymous environment like the Internet.

Upon receiving credit card information for verification, the bank validates first that the individual is logged into the bank, then that the individual is at the same IP address as the purchase, and finally that the credit card information entered into the browser-based shopping page is correct. If all three factors do not match, the value returned to the browser-based shopping page is that the purchase is rejected. It is understood that the factors described herein may include all, part, additional factors or any combination of any logical extension of this process.

For the purpose of this description, a shopping profile of the individual is written as a cookie on the local computer and this information is sent to the browser-based shopping site to be used to select additional products that may be of interest or select advertisements that may be of interest to the individual or a combination or both or any other logical extension of the this process may be used to display information or advertisements to the individual. The use of a cookie may be substituted with a link to a profile database online, or a profile file may be sent to the shopping site, or any logical extension of this process may be used. Method steps associated with the present disclosure can be performed by one or more programmable processors executing a computer program to perform functions of the disclosure by operating on input data and generating output. Method steps can also be performed by, an apparatus of the disclosure can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; CD-ROMs (Compact Disc Read-only Memory) and DVD-ROMs (Digital Versatile Disc Read-only Memory). The processor and the memory can be supplemented by, or incorporated in special purpose logic circuitry.

To provide for interaction with a user, aspects of the present disclosure can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Aspects of the present disclosure can be implemented in a computing system that includes a back-end component, e.g., as a data server, or that includes a middle-ware component, e.g., an application server, or that includes a front-end component, e.g., a client computer having a graphical interface or a Web browser through which a user can interact with an implementation of the present disclosure, or any combination of such back-end, middleware, or front-end components. The components of the computing system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on respective computers and having a client-server relationship to each other.

Examples of types of computers include desktop computers, laptop computers, mobile telephones, tablet computers, and e-readers.

Numerous additional modifications and variations of the present disclosure are possible in view of the above-teachings. It is therefore to be understood that within the scope of the appended claims, the present disclosure may be practiced other than as specifically described herein. For example, elements and/or features of different illustrative embodiments may be combined with each other and/or substituted for each other within the scope of this disclosure and appended claims.

What is claimed is:

1. A method for selecting and displaying advertisements directed to an individual using a computer comprising:
providing to an individual a non-transitory tangible storage medium with a unique identifier that includes a non-browser based module for providing access to a validation server;
in response to the individual inputting the storage medium onto a local computer, loading into virtual memory and executing the module and sending the unique identifier to the validation server;
upon the validation server verifying that the unique identifier is valid, downloading a first application module;
upon receipt of the application module, querying a profile server for the individual's profile data based on the unique identifier of the storage medium;
upon receipt of the profile data, querying the physical location of the current IP address of the individual;
querying an advertising server using the profile data and physical location of the individual; and
selecting and displaying advertisements to the individual using a computer based on the profile data and physical location of the individual.

2. The method of claim 1, wherein the non-transitory recording medium comprises at least one of a CD-ROM, Flash Drive, Memory Chip, and Flash Memory.

3. The method of claim 1, wherein the first application module may be a logon module and the individual must complete a logon process before any advertisements are displayed.

4. The method of claim 1, wherein the profile data and physical location of the individual are used to verify that the individual is logged on before the individual is approved for an online purchase.

5. The method of claim 1, wherein the advertisements can provide links to web pages to allow online purchases, provide graphical coupons, or print coupons for shopping.

6. The method of claim 1, wherein the computer is one of a desktop computer, laptop computer, mobile telephone, and tablet computer.

7. A method of advertising within virtual software applications on a computer comprising:
providing to an individual a non-transitory tangible storage medium with a unique identifier that includes a non-browser based module for providing access to a validation server;
in response to the individual inputting the storage medium onto a local computer, loading into virtual memory and executing the module and sending the unique identifier to the validation server;
upon the validation server verifying that the unique identifier is valid, downloading a first application module;
upon receipt of the application module, querying a profile server for the individual's profile data based on the unique identifier of the storage medium;
upon receipt of the profile data, querying the physical location of the current IP address of the individual;
querying an advertising server using the profile data and physical location of the individual; and
selecting and displaying advertisements to the individual using the computer based on the profile data and physical location of the individual.
